(19) United States
(12) Patent Application Publication
(10) Pub. No.: US 2013/0201404 A1
(43) Pub. Date: Aug. 8, 2013

(54) IMAGE PROCESSING METHOD

(71) Applicants: Chien-Ming Lu, Tainan City (TW); Yin-Ho Su, Tainan City (TW); Chien-Chang Lin, Tainan City (TW)

(72) Inventors: Chien-Ming Lu, Tainan City (TW); Yin-Ho Su, Tainan City (TW); Chien-Chang Lin, Tainan City (TW)

(21) Appl. No.: 13/368,345

(22) Filed: Feb. 8, 2012

(51) Int. Cl. H04N 5/14

(52) U.S. Cl. 348/699; 348/E05.062

(57) ABSTRACT

An image processing method of an image processing apparatus includes: determining static pixels and non-static pixels of a current image frame; dividing the current image frame into a plurality of blocks, wherein each block comprises a plurality of pixels; determining static blocks and non-static blocks of the current image frame by referring to at least the static pixels and the non-static pixels of the current image frame; and refining determination of the static pixels and the non-static pixels of the current image frame according to the static blocks and the non-static blocks.

### BACKGROUND OF THE INVENTION

1. Field of the Invention

The present invention relates to an image processing method, and more particularly, to an image processing method which can determine static pixels of image frames at an increased accuracy.

2. Description of the Prior Art

The motion estimation and motion compensation (MEMC) technique is used to generate interpolated frames for doubling a frame rate of video data displayed on a display. When the displayed video data includes static logos or static captions and the image objects behind these static logos/captions are moving, however, the interpolated frame may show a wrong position of these static logo/captions due to the wrong motion vector being affected by the moving objects (ideally, the motion vector of the region including the static logo/captions should be zero). These displayed static logo/captions may be blurred, which degrades the display quality.

### SUMMARY OF THE INVENTION

It is therefore an objective of the present invention to provide an image processing method which can determine static pixels of image frames accurately, and can set a motion vector of the region including the static pixels to be zero, to solve the above-mentioned problems.

According to one embodiment of the present invention, an image processing method of an image processing apparatus comprises: determining static pixels and non-static pixels of a current image frame; dividing the current image frame into a plurality of blocks, wherein each block comprises a plurality of pixels; determining static blocks and non-static blocks of the current image frame by referring to at least the static pixels and the non-static pixels of the current image frame; and refining determination of the static pixels and the non-static pixels of the current image frame according to the static blocks and the non-static blocks.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of an image processing method according to one embodiment of the present invention.

FIG. 2 is a video signal including a plurality of image frames.

FIG. 3 is a map showing static pixels.

FIG. 4 is a flowchart of the post process of Step 110 of the method shown in FIG. 1.

FIG. 5 is a diagram illustrating how to re-determine pixel P5 to be a static pixel.

FIG. 6 is a diagram illustrating how to divide the image frame into a plurality of blocks.

FIG. 7 is a map showing static pixels.

### DETAILED DESCRIPTION

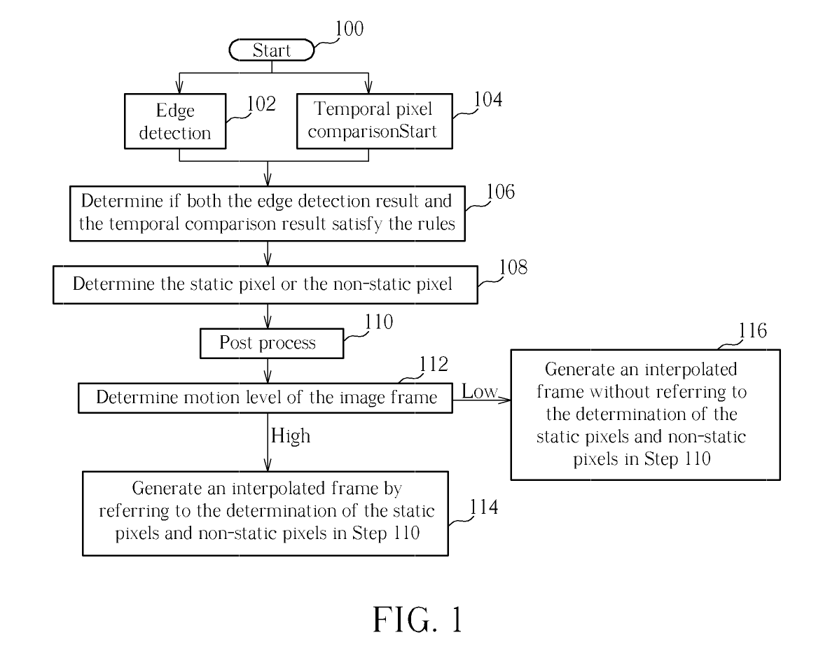

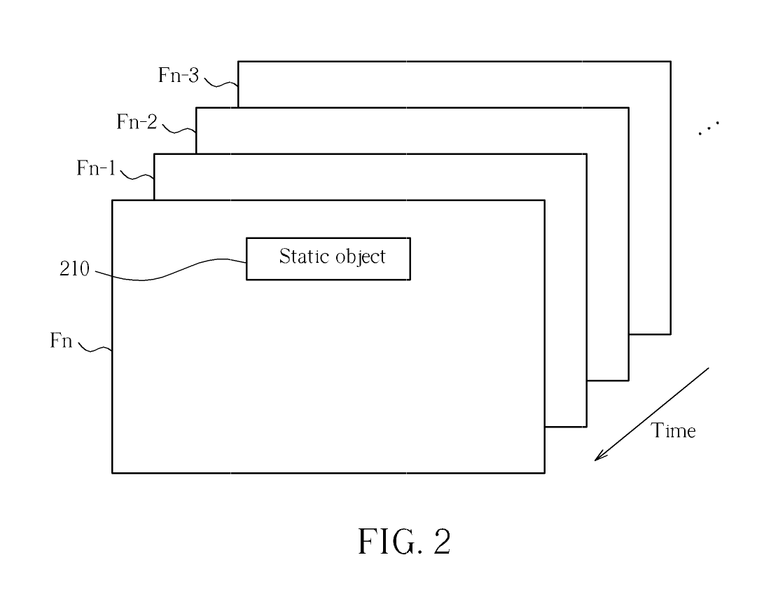

Please refer to FIG. 1, which illustrates an image processing method according to one embodiment of the present invention. In this embodiment, the image processing method of the present invention can be performed by a dedicated image processing circuit, or by executing a program code stored in a storage device. The method shown in FIG. 1 is used for processing the video signal frame by frame; that is, each of the frames shown in FIG. 2 is processed according to the method of FIG. 1. In the following description of the image processing method of FIG. 1, the image frame Fn shown in FIG. 2 is taken as an example for illustrating the flow.

In addition, the image frames shown in FIG. 2 are down-sampled from a full high definition (HD) video signal. For example, the resolution of full HD is 1920*1080, and the resolution of the frames shown in FIG. 2 can be 480*270. In addition, the static object 210 shown in FIG. 2 can be static logo/captions or any other non-video source.

In Step 100, the flow starts. In Step 102, taking a first pixel in the image frame Fn as an example, a Sobel horizontal filter and a Sobel vertical filter are used to determine if the first pixel is an edge in the image frame Fn. In detail, the Sobel horizontal filter is applied upon the first pixel to generate a horizontal filtered result Ex, the Sobel vertical filter is applied upon the first pixel to generate a vertical filtered result Ey, and then the following formula is used to determine if the first pixel is an edge in the image frame Fn.

if max(Ex, Ey)>(var+th1), the first pixel is an edge in the image frame Fn; and if max(Ex, Ey)<=(var+th1), the first pixel is not an edge in the image frame Fn; where “var” is a mean variance of the first pixel and its neighboring pixels, and “th1” is a threshold value.

It should be noted that the above-mentioned edge detection method is merely an example rather than a limitation of the present invention. In other embodiments of the present invention, the other edge detection method can be used to determine if the first pixel is an edge in the image frame Fn.

In Step 104, the pixel value (brightness value) of the first pixel of the image frame Fn is compared with the pixel value of the first pixel of a previous image frame Fn−1 to generate a temporal comparison result, where the temporal comparison result indicates whether these two pixels values are the same (or close to each other).

In Step 106, it is determined if both the edge detection result and the temporal comparison result satisfy the rules. For example, when the first pixel is determined to be an edge in the image frame Fn and the temporal comparison result indicates that the pixel values of the first pixels in the image frames Fn and Fn−1 are the same (or close to each other), it is determined that the edge detection result and the temporal comparison result satisfy the rules.

Then, in Step 108, it is determined if the first pixel in the image frame Fn is a static pixel or a non-static pixel according to the determination of Step 106 and static pixels in the previous image frames Fn−1, Fn−2, . . . . That is, if a great portion of the first pixels in the image frames Fn, Fn−1, . . . are determined to satisfy the rule in Step 106, the first pixel in the image frame Fn is determined as a static pixel; otherwise the first pixel in the image frame Fn is determined as a non-static pixel.

In one embodiment, in Step 108, a buffer can be used to store a counting value that indicates how many first pixels in the image frames satisfy the rule in Step 106. When the first pixel in one frame satisfies the rule in Step 106, the counting value is increased by an increment of “1”, and when the first pixel in one frame does not satisfy the rule in Step 106, the counting value is decreased by a decrement of “1”. Then, for the first pixel in the image frame Fn, the counting value is compared with a threshold to determine if the first pixel in the image frame Fn is a static pixel or a non-static pixel. That is, when the counting value is greater than the threshold, the first pixel is determined to be a static pixel; and when the counting value is not greater than the threshold, the first pixel is determined to be a non-static pixel.

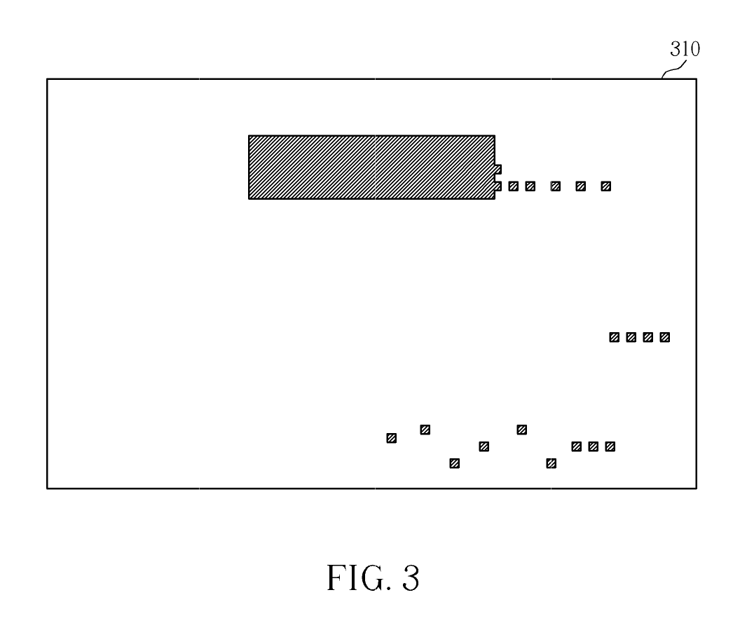

After all the pixels in the image frame Fn are processed by Steps 102-108, the pixels in the image frame Fn are categorized into static pixels and non-static pixels. In this embodiment, the value of the static pixels is set to be “1”, and the value of the non-static pixels is set to be “0”. FIG. 3 shows a map 310 representing the static pixels and non-static pixels of the image frame Fn, where the shading area is the determined static pixels in Step 108.

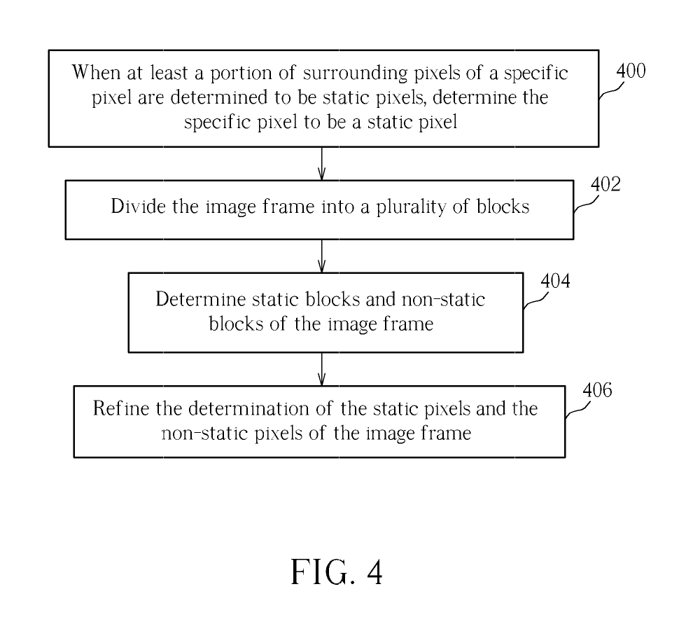

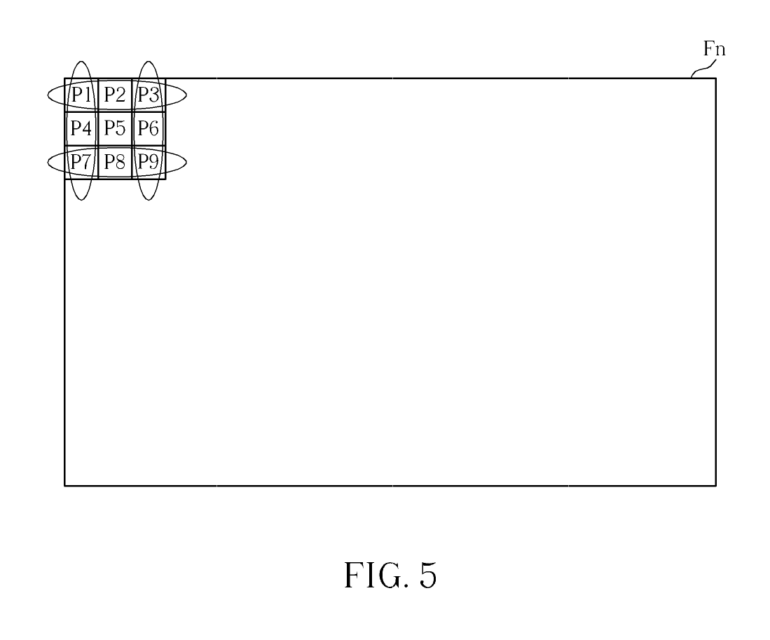

After the static pixels and the non-static pixels in the image frame Fn are determined, the flow enters Step 110 to perform post processing. Please refer to FIG. 4, which is a flowchart of the post process of Step 110. In Step 400, for a specific pixel of the image frame Fn, when at least a portion of the surrounding pixels are determined to be static pixels, the specific pixel is determined to be a static pixel no matter whether the specific pixel is determined as a non-static pixel in Step 108. For example, please refer to FIG. 5: if the pixel P5 is determined as a non-static pixel and most of its surrounding pixels (i.e. two columns or two rows of the surrounding pixels shown in FIG. 5) are determined as static pixels in Step 108, the pixel P5 is re-determined to be a static pixel.

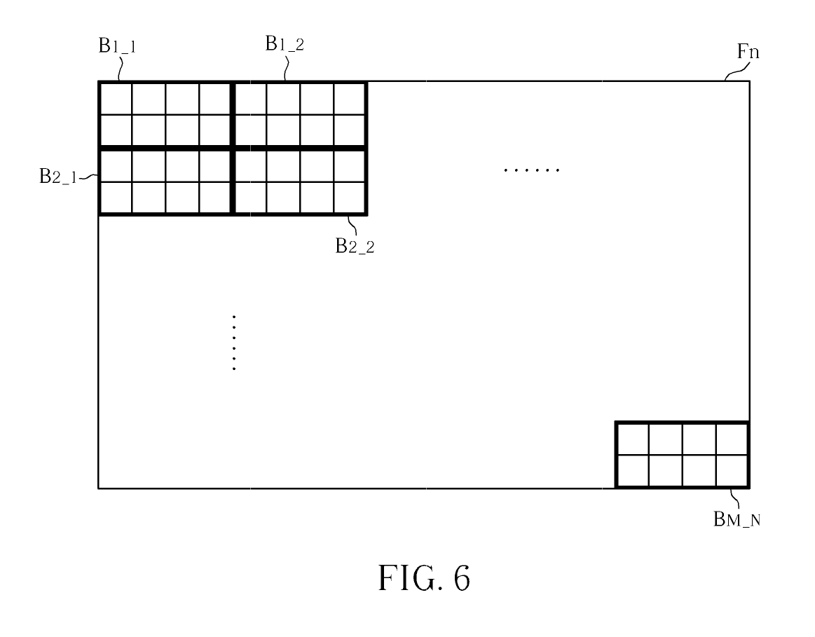

Then, in Step 402, the image frame Fn is divided into a plurality of blocks B₁_{_{—}}₁-B_{M}_{_{—}}_{N}, where each block includes a plurality of pixels. In this embodiment, each block includes eight pixels as shown in FIG. 6.

In Step 404, static blocks and non-static blocks of the image frame Fn are determined by referring to at least the static pixels and the non-static pixels determined in Step 108 and 400. In this embodiment, for each of the blocks, when the block includes at least one static pixel, the block is determined as a static block; otherwise the block is determined as a non-static block. Furthermore, for a specific block, when at least a portion of the surrounding block are determined to be non-static blocks, this specific block is determined as a non-static block. For example, if the block B₁₋₁ is determined as a static block and its surrounding blocks B₁_{_{—}}₂, B₂_{_{—}}₁ and B₂_{_{—}}₂ are determined as non-static blocks, the block B₁_{_{—}}₁ is re-determined to be a non-static block.

In one embodiment, in Step 404, a 3*5 buffer array can be used to store temporal determinations of the 3*5 blocks (in the following descriptions, blocks B₁_{_{—}}₁-B₃_{_{—}}₅ shown in FIG. 6 are taking as an example, and the block B₂_{_{—}}₃ serves as the specific block) of the image frame Fn. Each buffer stores a value that represents whether the corresponding block is static or not. For example, if the block B₁_{_{—}}₁ in the image frame Fn and its two previous frames Fn−1 and Fn−2 are determined to be a static block, the buffer corresponding to the block B₁₋₁ is set to have a value “1”; otherwise the buffer is set to have a value “0”. Then, the values in the 3*5 buffer array are summed to obtain a score. When the score is greater than a threshold (e.g., “3”), the block B₂_{_{—}}₃ is determined as a static block; and When the score is not greater than the threshold, the block B₂_{_{—}}₃ is determined as a non-static block.

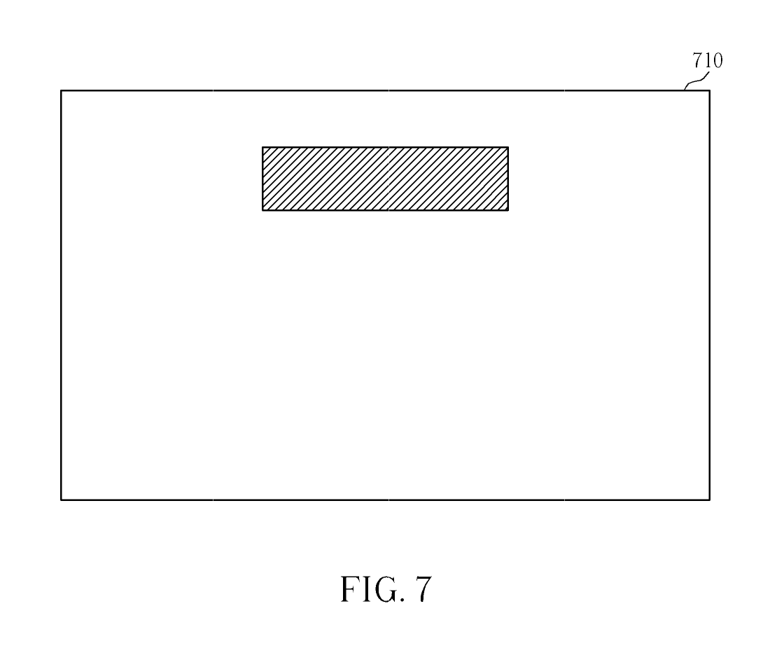

Then, in Step 406, the determination of the static pixels and the non-static pixels of the image frame Fn is refined according to the static blocks and the non-static blocks. In detail, if any of the determined non-static blocks include static pixel(s), the static pixel(s) are re-determined as non-static pixel(s); and if any of the determined static blocks include non-static pixel(s), the non-static pixel(s) are re-determined as static pixel(s). FIG. 7 shows a map 710 representing the re-determined static pixels and non-static pixels of the image frame Fn, where the shading area is the static pixels. Compared with the map 310 shown in FIG. 3, the map 710 clearly shows the static object 210 in FIG. 2, and the unnecessary static pixels are removed.

Then, the flow returns to Step 112 shown in FIG. 1. In Step 112, a motion level of the current image frame is determined. For example, the motion level can be a maximum regional motion vector of a plurality of regional motion vectors, where the plurality of regional motion vectors correspond to a plurality of regions of the image frame Fn; or the motion level can be a global motion vector of the image frame Fn; or the motion level can be a maximum of the regional motion vectors and the global motion vector. Because the determinations of the region motion vectors and the global motion vector are well known by a person skilled in this art, further descriptions are omitted here.

When the motion level is high (i.e. the motion level is greater than a threshold), the flow enters Step 114; and when the motion level is low (i.e. the motion level is lower than the threshold), the flow enters Step 116.

In Step 114, a region including the static pixels shown in FIG. 7 is set to have a zero motion vector, and an interpolated image frame between the image frame Fn and its adjacent image frame is generated by referring to the region having the zero motion vector. Therefore, the position of the static object in the interpolated image frame will be exactly the same as the position of the static object 210 in the image frame Fn and its adjacent image frames. Because the position of the static object in the interpolated image frame can be correctly determined, the displayed static object is not blurred, and the display quality is therefore improved.

In Step 116, an interpolated image frame between the image frame Fn and its adjacent image frame is generated without referring to refined determination of the static pixels and the non-static pixels of the image frame Fn shown in FIG. 7. That is, when the motion level of the image frame Fn is low, the determined results of the Step 100-112 are omitted in the steps of generating the interpolated image frame.

Briefly summarized, in the image processing method of the present invention, the static object of the image frame is determined in a pixel domain and re-determined in a block domain. Therefore, the determination of the static object of the image frame is more reliable, and quality of the interpolated frame is improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method of an image processing apparatus, comprising:
determining static pixels and non-static pixels of a current image frame;
dividing the current image frame into a plurality of blocks, wherein each block comprises a plurality of pixels;
determining static blocks and non-static blocks of the current image frame by referring to at least the static pixels and the non-static pixels of the current image frame; and
refining determination of the static pixels and the non-static pixels of the current image frame according to the static blocks and the non-static blocks.

2. The image processing method of claim 1, wherein the step of determining the static pixels and the non-static pixels of the current image frame comprises:
utilizing a spatial filter upon each pixel of the current image frame, and comparing pixel values between the current image frame and an adjacent image frame to determine the static pixels and the non-static pixels of the current image frame.

3. The image processing method of claim 2, wherein the step of determining the static pixels and the non-static pixels of the current image frame further comprises:
referring to static pixels of a plurality of image frames previous to the current image frame to determine the static pixels and the non-static pixels of the current image frame.

4. The image processing method of claim 1, wherein the step of determining the static pixels and the non-static pixels of the current image frame comprises:
for a specific pixel of the current image frame, when at least a portion of surrounding pixels are determined to be static pixels, determining the specific pixel to be a static pixel.

5. The image processing method of claim 1, wherein the step of determining the static blocks and the non-static blocks of the current image frame comprises:
for each of the blocks, when the block includes at least one static pixel, determining the block to be a static block.

6. The image processing method of claim 1, wherein the step of determining the static blocks and the non-static blocks of the current image frame comprises:
for a specific block of the current image frame, when at least a portion of surrounding block are determined to be non-static blocks, determining the specific block to be a non-static block.

7. The image processing method of claim 6, wherein the step of refining determination of the static pixels and the non-static pixels of the current image frame comprises:
when the specific block includes at least a static pixel, re-determining the static pixel as a non-static pixel.

8. The image processing method of claim 1, further comprising:
after refining determination of the static pixels and the non-static pixels of the current image, setting at least one region including static pixels only to have a zero motion vector.

9. The image processing method of claim 8, further comprising:
generating an interpolated image frame between the current image frame and its adjacent image frame by referring to the region having the zero motion vector.

10. The image processing method of claim 8, further comprising:
determining a motion level of the current image frame;
when the motion level is greater than a threshold, generating an interpolated image frame between the current image frame and its adjacent image frame by referring to the region having the zero motion vector; and
when the motion level is lower than the threshold, generating an interpolated image frame between the current image frame and its adjacent image frame without referring to the refined determination of the static pixels and the non-static pixels of the current image frame.

11. The image processing method of claim 10, wherein the step of determining the motion level of the current image frame comprises:
determining a plurality of regional motion vectors corresponding to a plurality of regions of the current image frame, respectively;
wherein the motion level is a maximum regional motion vector of the regional motion vectors.

12. The image processing method of claim 10, wherein the step of determining the motion level of the current image frame comprises:
determining a global motion vector of the current image frame to be the motion level.

13. The image processing method of claim 10, wherein the step of determining the motion level of the current image frame comprises:
determining a plurality of regional motion vectors corresponding to a plurality of regions of the current image frame, respectively; and
determining a global motion vector of the current image frame;
wherein a maximum of the regional motion vectors and the global motion vector serves as the motion level.

14. The image processing method of claim 1, wherein the current image frame is down-sampled from a full high definition image frame.
